(19) United States
(12) Patent Application Publication
(10) Pub. No.: US 2003/0081234 A1
(43) Pub. Date: May 1, 2003

(54) Document delivery methods and multifunction device therefor

(76) Inventor: Jeffrey G. Wiley, Greeley, CO (US)

Correspondence Address: HEWLETT-PACKARD COMPANY, Intellectual Property Administration, P.O. Box 272400, Fort Collins, CO, 80527-2400, US

(21) Appl. No.: 10/002,354

(22) Filed: Oct. 30, 2001

(51) Int. Cl. B41B 1/00; G06F 15/00

(52) U.S. Cl. 358/1.13; 358/1.15

(57) ABSTRACT

Document delivery methods and multifunction device therefor. The invention is preferably embodied in computer-readable media operatively associated with a multifunction device and having computer-readable program code thereon. The computer-readable program code may include program code for identifying different types of network destinations to receive a document, program code for formatting the document for each of the different types of network destinations, and program code for sending the formatted document from the multifunction device to each of the different types of network destinations, wherein the document is imaged only once for delivery to each of the different types of network destinations.

### FIELD OF THE INVENTION

The invention generally pertains to multifunction devices, and more specifically, to document delivery methods and multifunction devices therefor.

### BACKGROUND OF THE INVENTION

Multifunction devices offer a convenient way of communicating with a variety of devices from an individual stand-alone device. Briefly, multifunction devices may be used to convert a paper document to an electronic image thereof, and then to transmit the electronic image to a variety of network destinations. For example, the multifunction device may be used to send the electronic image of the paper document to an email account, a facsimile machine, a printer, a copier, an Independent Software Vendor (ISV) application, a mobile phone, and an Internet site, to name but a few such network destinations.

As an illustration, the user may send a paper document to a recipient as follows. The user positions a paper document in the automatic document feeder (ADF) or directly on the imaging bed of the multifunction device. The user then activates the multifunction device, for example, by pressing a “start” button. In turn, the multifunction device converts the paper document to an electronic image thereof. The user may identify a recipient for the electronic image of the paper document. For example, the user may identify a recipient by keying in a facsimile number, an email account, etc., using the keypad of the multifunction device 100. Or for example, the user may identify a recipient by selecting the same from a menu or address book shown on the display at the multifunction device. The multifunction device then sends the electronic image of the paper document over a suitable network (e.g., the Internet, an Intranet) to the recipient at any of a number of various network destinations.

In some circumstances the user may want to send the same document to different types of devices. In one such circumstance, the user may want to send the document to more than one recipient, each having a different type of device for receiving documents. As an illustration, a project engineer may want to send an article related to a current project to the other engineers working on the project, wherein several of the other engineers have different devices for receiving documents. For example, one engineer may have a facsimile machine, while another engineer may have an email account. In another such circumstance, the user may want to send the document to the same recipient at different alternate devices. As an illustration, one of the other engineers may have access to an office facsimile machine and also have a personal email account. Accordingly, the user may send the article to the other engineer at both the office facsimile machine and also at his or her personal email account to increase the likelihood that the other engineer receives the article whether he or she is at the office, or perhaps when traveling, only has access to his or her personal email account.

Typically, when the user wants to send the document to different types of devices, the user must (1) select the type of destination (e.g., email, fax, etc.); (2) enter the destination address (e.g., email address, facsimile number, etc.); (3) feed and scan the document using the multifunction device; and (4) repeat these steps until the document has been sent to each of the different types of devices. This is time consuming and inconvenient for the user, especially when the document includes many pages, each of which must be scanned and rescanned at the multifunction device.

### SUMMARY OF THE INVENTION

An embodiment of document delivery methods according to the teachings of the invention may comprise the steps of: identifying different types of network destinations for receiving a document, formatting the document for each of the different types of network destinations without re-imaging the document, and sending the formatted document to each of the different types of network destinations from a multifunction device.

Another embodiment of document delivery methods may comprise the steps of: converting a printed document to an electronic document only once with a multifunction device, identifying different types of network destinations to receive the electronic document, formatting the electronic document for each of the different types of network destinations, and sending the formatted electronic document from the multifunction device to each of the identified different types of network destinations.

Multifunction device for delivering documents to different types of network destinations according to the teachings of the invention may comprise computer-readable media operatively associated therewith and having computer-readable program code thereon. The computer-readable program code may include program code for identifying different types of network destinations to receive a document, program code for formatting the document for each of the different types of network destinations, and program code for sending the formatted document from the multifunction device to each of the different types of network destinations, wherein the document is imaged only once for delivery to each of the different types of network destinations.

### BRIEF DESCRIPTION OF THE DRAWINGS

Illustrative and presently preferred embodiments of the invention are illustrated in the drawings, in which:

FIG. 1 is a high-level diagram illustrating a multifunction device for delivering documents to different types of network destinations according to embodiments of the invention;

FIG. 2 is a detailed view of a portion of the multifunction device for delivering documents showing an embodiment of an interface of the multifunction device;

FIG. 3 is another embodiment of the interface, including user functions;

FIG. 4 is yet another embodiment of the interface, also including user functions;

FIG. 5 is still another embodiment of the interface, also including user functions; and

FIG. 6 is a flow chart illustrating document delivery methods according to embodiments of the invention.

### DESCRIPTION OF THE PREFERRED EMBODIMENT

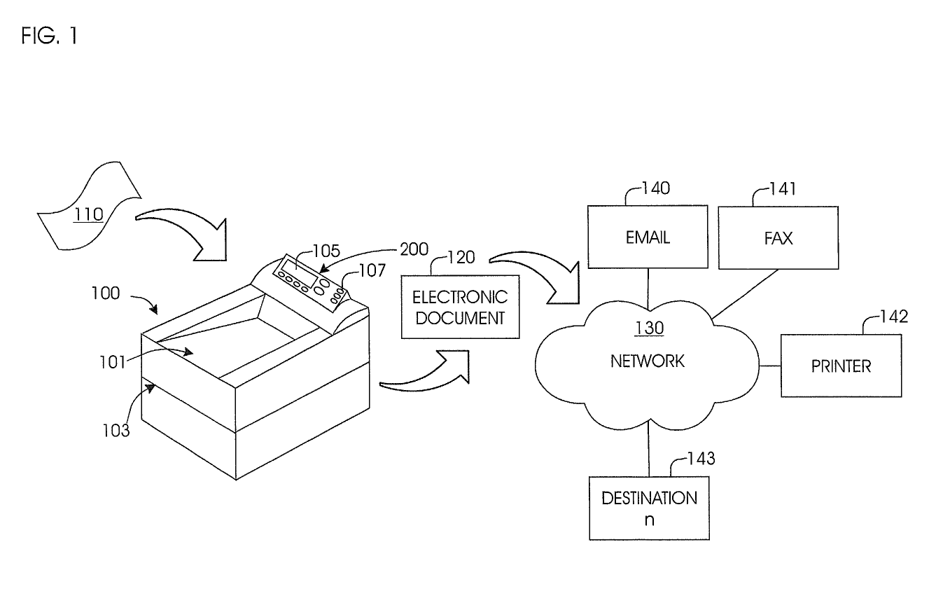

Multifunction device 100 (FIG. 1) is shown and described herein as it may be used for delivering a document 110 to different types of network destinations 140-143 (e.g., a facsimile machine, an email account, a printer, a copier, etc.) according to embodiments of the invention. The user may position a paper document 110 in the automatic document feeder (ADF) 101 or directly on the imaging bed 103 of the multifunction device 100, identify a recipient for the document, and activate the multifunction device 100. In turn, the multifunction device 100 converts the paper document 110 to an electronic image thereof (e.g., electronic document 120), and sends the electronic document 120 over a suitable network (e.g., the Internet, an Intranet) to the recipient.

According to the teachings of the invention, the multifunction device 100 may comprise computer-readable media operatively associated therewith and having computer-readable program code thereon. The computer-readable media may comprise one or more of any suitable media, as explained in more detail below. Likewise, the computer-readable program code may reside on the computer-readable media in any suitable manner, also as explained in more detail below. The computer-readable program code may include program code for identifying different types of network destinations 140-143 to receive the document 110, program code for formatting the document for each of the different types of network destinations 140-143, and program code for sending the formatted document 110 to each of the different types of network destinations 140-143. Accordingly, the document 110 is imaged only once for delivery to each of the different types of network destinations 140-143.

The multifunction device 100 may be operated as follows for delivering a document 110 to different types of network destinations 140-143. Preferably, different types of network destinations 140-143 are identified for receiving the document 110. For example, a facsimile machine, an email account, and a network printer may each be identified for receiving the document 110. The document 110 may be formatted for each of the different types of identified network destinations 140-143 without re-imaging the document 110. For example, the document 110 may be formatted for receipt at the facsimile machine, at the email account, and at the network printer, respectively. The formatted document may then be sent to each of the identified different types of network destinations 140-143 from the multifunction device 100.

Accordingly, the document 100 is imaged only once and then delivered to each of the different types of network destinations 140-143. The user does not have to (1) select the type of destination (e.g., email, fax, etc.); (2) enter the destination address (e.g., email address, facsimile number, etc.); (3) feed and scan the document using the multifunction device; and (4) repeat these steps until the document has been sent to each of the different types of devices.

Having generally described document delivery methods and multifunction device therefor, as well as some of the features and advantages, the various embodiments of the invention will now be described in further detail.

A multifunction device 100 for delivering a document 110 over a suitable network 130 to different types of network destinations 140-143 according to embodiments of the invention is shown in FIG. 1. The multifunction device 100 preferably comprises an imaging component (e.g., a scanner), and an interface 200 (e.g., display 105, keypad 107), and may be linked over a suitable network 130 (e.g., the Internet, an Intranet, etc.). The document is preferably imaged once and then sent, for example, to an email account 140, a facsimile machine 141, a printer 142, or other device (e.g., Destination n (143)).

Preferably, computer-readable media may be provided having computer-readable program code thereon for delivering the document 110 to different types of network destinations 140-143. The computer-readable media may comprise any suitable media that is now known or is later developed. For example, the computer-readable media may comprise media such as attached storage (e.g., a hard disk drive), random access memory (RAM), removable media (e.g., a compact disc (CD)), etc. In addition, it is understood that the computer-readable program code may comprise a software application, an executable file (e.g., an applet), routines, subroutines, etc. Indeed, the computer-readable program code may access other computer-readable program code for performing one or more tasks. In addition, the computer-readable program code may be stored in whole on a single computer-readable medium, or various components of the computer-readable program code may be stored on more than one computer-readable media. Preferred embodiments of the computer-readable program code are explained in more detail below.

Before continuing, the term “paper” document (i.e., document 110), as used herein, is intended to encompass any document that may be converted to electronic format using the multifunction device 100. For example, such a document may comprise photocopies, printed paper, photographs, note cards, slides, viewgraphs, color documents, black/white documents, etc. In addition, more than one paper document 110 may be converted to electronic format. For example, several pages of a paper document 110 may be imaged using the automatic document feeder 101, or the user may individually image each page of a paper document 110 using the imaging bed 103.

Continuing now with a more detailed description of the invention, the multifunction device 100 is preferably enabled for connection to a Transmission Control Protocol/Internet Protocol (TCP/IP) network 130. However, the multifunction device 100 may be connected over any suitable network or networks, including but not limited to, a local area network (LAN), a wide area network (WAN), a secure network, an Intranet, the Internet, a telephone network, a combination thereof, etc. Likewise, the multifunction device 100 may be linked to the network 130 in any suitable manner, including but not limited to a hardwired connection, an infrared connection, via satellite, via dial-up connection (i.e., using a modem), a dedicated connection (e.g., cable, digital subscriber line (DSL), T-1, T-3), etc.

In one preferred embodiment, the multifunction device 100 is an HP DIGITAL SENDER™ 9100C (Hewlett Packard Company, Palo Alto, Calif.). The HP DIGITAL SENDER™ 9100C is enabled for sending documents to Internet email accounts, facsimile machines, to PCs (e.g., for viewing or editing with suitable software applications), to a network folder, etc. In another embodiment, the multifunction device 100 may comprise a multifunction peripheral (MFP), such as the HP OFFICE JET® G95 available from Hewlett-Packard Company. The HP OFFICE JET® G95 is enabled for printing, copying, facsimileing, and scanning documents. However, it is understood that any suitable multifunction device, now known or later developed, may be used according to the teachings of the embodiments of the invention. Indeed, it is understood that in other embodiments, the multifunction device 100 may be another multifunction device or multifunction peripheral, a network digital copier, an “all-in-one” device for attachment to a PC, a document management machine, a network-capable scanner, etc. Accordingly, the present invention should not be regarded as limited to use with the particular multifunction device 100 shown and described herein.

The multifunction device 100 may be used to convert the document 110 to electronic format. Preferably, the document 110 is electronically imaged, and the electronic image of the paper document 110 is preferably combined with at least delivery or routing information (e.g., electronic document 120) so that it can be sent from the multifunction device 100 to the network destination 140-143 specified by the user.

More specifically, the electronic document 120 may comprise a header, a message, and an attached document. The header preferably identifies routing information for the electronic document 120, such as the recipients, the sender, and any other suitable information in any suitable format. The message may be included for conveying additional information to the recipient. Although the message may take any suitable format, it preferably includes instructional text or identifying information, much like that which may be included on a facsimile cover sheet. The attached document is preferably the electronic image of the paper document 110, and according to the teachings of the invention, may further comprise the accessed data 155. In any event, the electronic document 120 is preferably formatted so that the recipient may view it with readily-available software (e.g., ADOBE® READER®, an email application, a web browser), or so that it can be converted for output from a readily-available device (e.g., another multifunction device, a facsimile machine, a printer, a photocopier).

The various components of the electronic document 120 are preferably assembled automatically and transparently to the user. That is, the user preferably only needs to specify a recipient, position the paper document 110 in the ADF 101 or directly on the flatbed scanner 103, and activate the multifunction device 100. The multifunctional peripheral 100, using suitable program code, then images the paper document 110, includes it with the various components of the electronic document 120, and sends it to the network destination 140-143. Few, if any, additional steps are required by the user to send the document from the multifunction device.

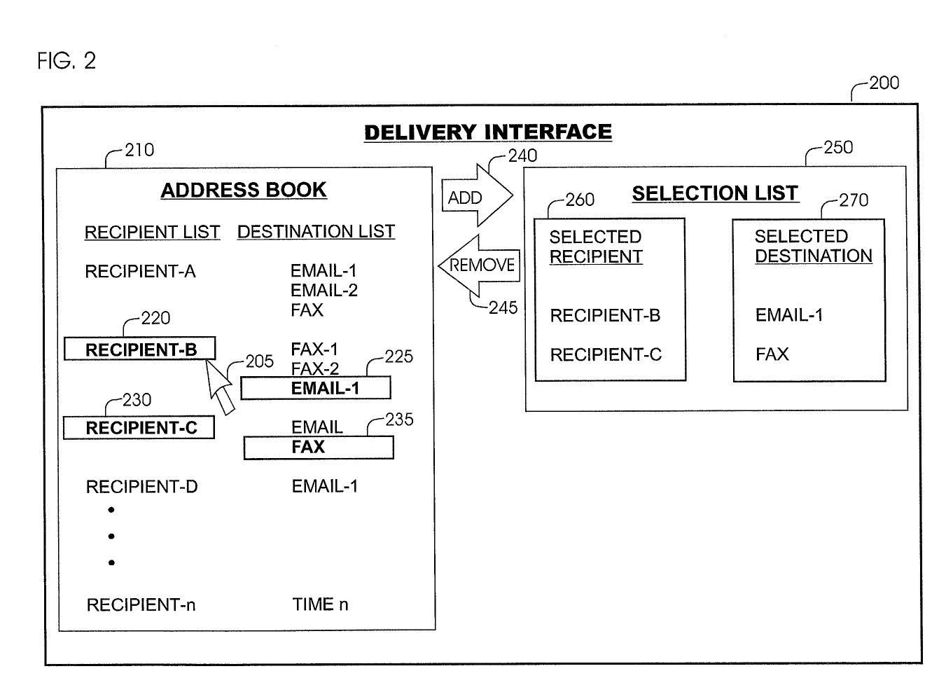

In any event, once the document 110 is imaged, the multifunction device 100 may be used to deliver the imaged document (e.g., electronic document 120) to different types of network destinations 140-143. Preferably, the multifunction device 100 is provided with a delivery interface 200 (FIG. 2) so that a user may interact with the multifunction peripheral 100 to specify the different types of network destinations 140-143.

Exemplary interfaces are shown in FIG. 2 through FIG. 5 and are described in further detail below to illustrate various embodiments of the invention. In these illustrations, the delivery interface 200 is preferably a graphical user interface (GUI) such as the user may interact with using the display 105 and keypad 107 of the multifunction device 100.

Before continuing to describe the exemplary interfaces 200 shown in FIG. 2 through FIG. 5, it should be understood that other embodiments of the interface are also contemplated as being within the scope of the invention. For example, the interface may comprise one or more Internet web pages (e.g., hypertext markup language (HTML) pages) for display with an Internet browser and linked to the multifunction device 100. In another embodiment, the interface may comprise a software application for use with a PC linked to the multifunction device 100. Still other embodiments of the interface are also contemplated as being within the scope of the invention. For example, in other embodiments, a suitable interface may be provided for use with a mobile phone, a PDA, etc.

It should also be understood that an address book 210 is shown for purposes of illustration in FIG. 2 through FIG. 5. However, in other embodiments, the user need not access an address book 210 to select the network destinations 140-143, and instead, the user may manually specify the network destinations 140-143. Likewise, in other embodiments, the user may both manually enter one or more of the network destinations and also select one or more of the network destinations from the address book 210.

Turning now to the first exemplary delivery interface 200 shown in FIG. 2, the delivery interface 200 preferably comprises a window displaying an address book 210 and a window displaying the user's selections 250. The address book 210 preferably comprises computer-readable data defining a number of recipients and one or more destinations corresponding to each of the recipients. For example, the recipient may be defined by meta data (e.g., a person's name, a device name, etc.), and the corresponding destinations may comprise an email account, facsimile number, mobile phone number, network address (e.g., Internet Protocol (IP) address), etc.

The user may specify the different types of network destinations 140-143 for the document 110 using the delivery interface 200 as follows. The user may move the pointer or cursor 205 (e.g., using keys 107 or a PC mouse) to the window displaying the address book 210 and “click” on a plurality of recipients and/or a plurality of network destinations for the document 110. For example, the user has selected two recipients (i.e., RECIPIENT-B (220) and RECIPIENT-C (230)), and the user has also selected the corresponding network destinations (i.e., EMAIL-1 (225) and FACSIMILE (235)), as indicated by the boldface font and the box surrounding each selection in FIG. 2. The user may click the ADD button 240 to select a recipient and/or destination for the document 110. The user may also unselect a recipient and/or destination by clicking on the REMOVE button 245.

In any event, once the user has selected the recipients and/or destinations for the document 110, program code is preferably provided for identifying the different types of network destinations 140-143 selected by the user. For example, the program code may identify the different types of network destinations 140-143 as email account(s) 140 and facsimile machine(s) 141. The document 110 in electronic format may be formatted for the type of network destination 140-143 that will receive it. For example, the electronic document 120 may be formatted as hypertext markup language (HTML) for sending to an email account 140. Or for example, the electronic document 120 may be formatted as audible signals for sending to a facsimile machine 141. The document 110 so formatted may then be sent in electronic format from the multifunction device 100 to each of the different types of identified network destinations 140-143.

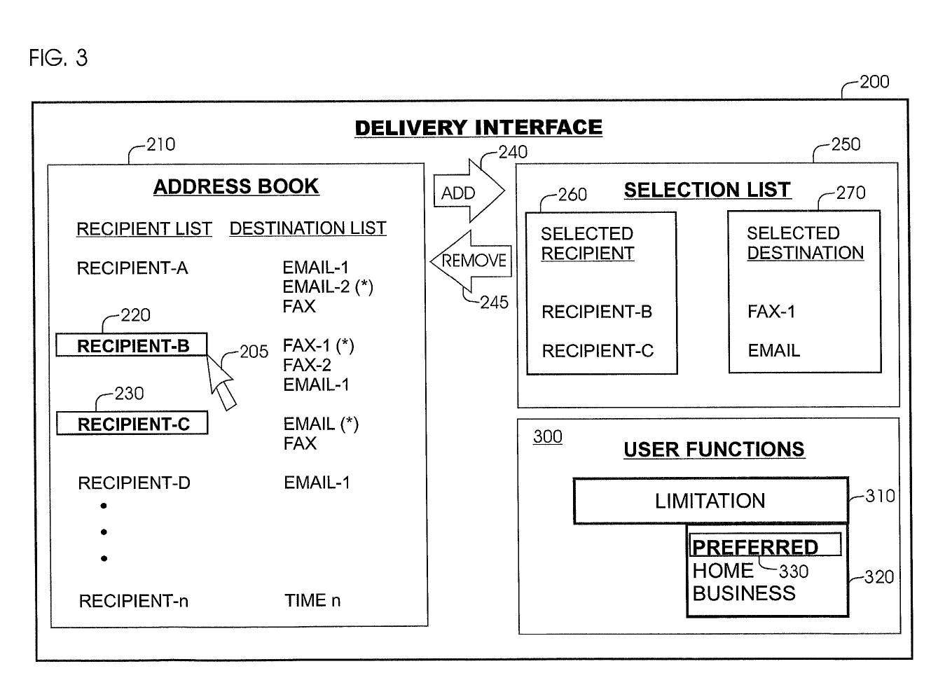

Another exemplary delivery interface 200 is shown in FIG. 3, again comprising windows for displaying an address book 210 and the user's selections 250. The user may specify a plurality of recipients for the document 110 using the delivery interface 200, as described above. In the illustration of FIG. 3, the user has selected two recipients (i.e., RECIPIENT-B (220) and RECIPIENT-C (230)), as indicated by the boldface font and the box surrounding each selection. In addition, the delivery interface 200 may comprise a window for displaying one or more functions 300 that are provided for the user. For example, the functions 300 may allow the user to universally limit the selections, as shown in the following illustration.

The selected recipients 220, 230 in the illustration shown in FIG. 3 have more than one corresponding destination. For example, RECIPIENT-B (220) has two facsimile numbers (i.e., FAX-1 and FAX-2) and an email account (i.e., EMAIL-1). Likewise, RECIPIENT-C has a facsimile number (i.e., FACSIMILE) and an email account (i.e., EMAIL). In addition, the user has only selected recipients, and has not selected any network destinations. Instead, the user may select the limitation function 310 to specify the type of network destinations 140-143. For example, the user may select the limitation “PREFERRED” (330) from the menu 320, as indicated by the boldface font and the box surrounding the selection in FIG. 3.

Program code is preferably provided for the functions 300. In the above illustration, program code is provided for sorting the network destinations based on the limitation 310. Preferably, the limitation is indicated in the address book 210 (e.g., the asterisks in FIG. 3). Thus, the program code may identify network destinations 140-143 based on the indicated limitation. For example, the network destinations FAX-1 and EMAIL may be identified for RECIPIENT-B and RECIPIENT-C, respectively, as shown in windows 260 and 270 of FIG. 3. The program code does not identify EMAIL-1, FAX-2, and FACSIMILE, for the respective recipients in this example, as these are not indicated to be preferred destinations.

Preferably, the user may sort the selected destinations by any suitable limitation 310. In other embodiments, for example, the user may sort by “home” address, “business” address, etc. Accordingly, the program code identifies only the network destinations 140-143 indicated by the limitation 310. Again, the multifunction device 100 may send the document 110 to the identified network destinations 140-143 regardless of the device type (e.g., facsimile, email, etc.), without the user having to rescan the document 110.

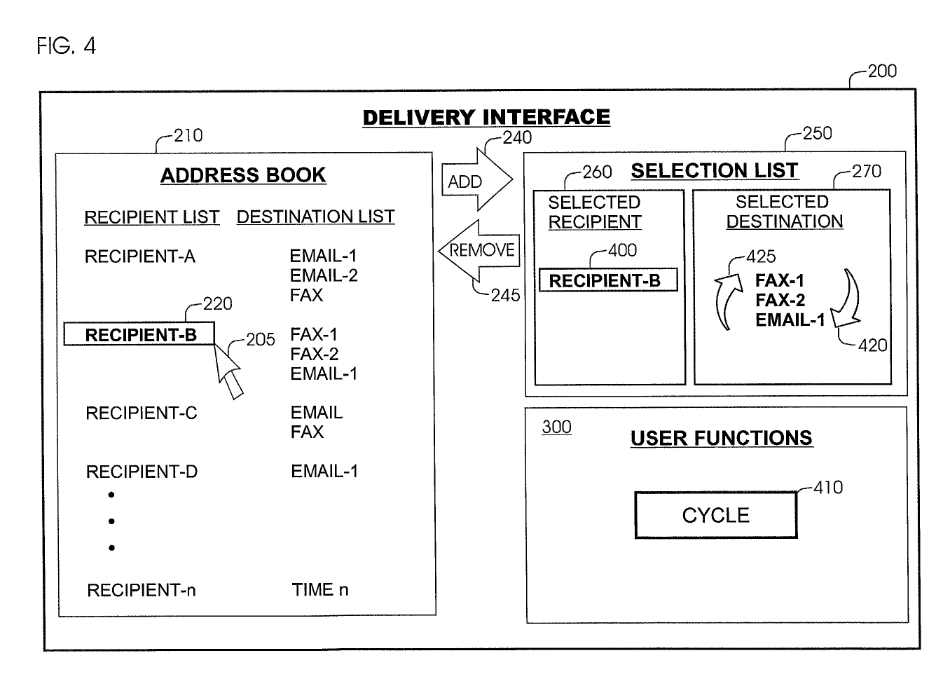

Another exemplary delivery interface 200 is shown in FIG. 4. Again the delivery interface 200 preferably comprises windows for displaying an address book 210, user selections 250, and user functions 300. The user may select one or more recipients for the document 110 using the delivery interface 200, as explained above. For example, the user has selected one recipient (i.e., RECIPIENT-B (220)), as indicated by the boldface font and the box surrounding the selection in FIG. 4.

The selected recipient 220 may have more than one corresponding destination. For example, RECIPIENT-B (220) has two facsimile numbers (i.e., FAX-1 and FAX-2) and an email account (i.e., EMAIL-1). In some circumstances, the user may want to have the document 110 sent to each of the network destinations 140-143 for the selected recipient. For example, the user may want to send the document 110 to the recipient at more than one device so that the recipient is more likely to receive the document 110, regardless of whether the recipient has access to the office facsimile (e.g., FAX-1), the home-office facsimile (e.g., FAX-2), or is traveling and may only have access to an email account (e.g., EMAIL-1). Suitable program code may be provided for formatting the document 110 for each of the identified network destinations 140-143, and for sending the document 110 thereto.

Alternatively, user functions 300 may be provided to cycle through the selected network destinations 140-143. According to one such embodiment, program code is provided for resending the document 110 to at least one of the network destinations 140-143 upon a predetermined condition being satisfied. That is, the predetermined condition may be satisfied when the document 110 is undeliverable to one or more of the network destinations 140-143. For example, the predetermined condition may be indicated by a facsimile busy signal, a “bounced” email message, a predetermined time passing without having received a return receipt, etc.

As an illustration, the user may select RECIPIENT-B, as indicated by the boldface font and the box 400 surrounding the selection in FIG. 4. The network destination “FAX-1” is identified, the document 110 is formatted for a facsimile machine, and it is sent from the multifunction device 100 to FAX-1. When a busy signal is detected, the next network destination “FAX-2” is identified, the document is, or remains, formatted for a facsimile machine, and it is sent from the multifunction device 100 to FAX-2. When a busy signal is again detected, the next network destination “EMAIL-1” is identified, the document is formatted for an email account, and it is sent from the multifunction device 100 to EMAIL-1. The program code may continue in this manner, as indicated by arrows 420, 425, until the multifunction device 100 is able to send the document 110 to at least one of the destinations for the selected recipient. In addition, the user need not rescan the document 110, and the document 110 may be sent to any of the different types of destinations (i.e., both facsimile and email in this example).

The program code described above may operate in conjunction with program code for recognizing a busy signal from a facsimile line, or with program code for managing return receipts. For example, when a return receipt is not received within a predetermined time after the document 110 is sent to a first destination (e.g., EMAIL-1), the document 110 may instead be sent to the next destination (e.g., FAX-1). Or for example, where the document 110 is “bounced” by the recipient's email server, the document 110 may instead be sent to the recipient's facsimile machine.

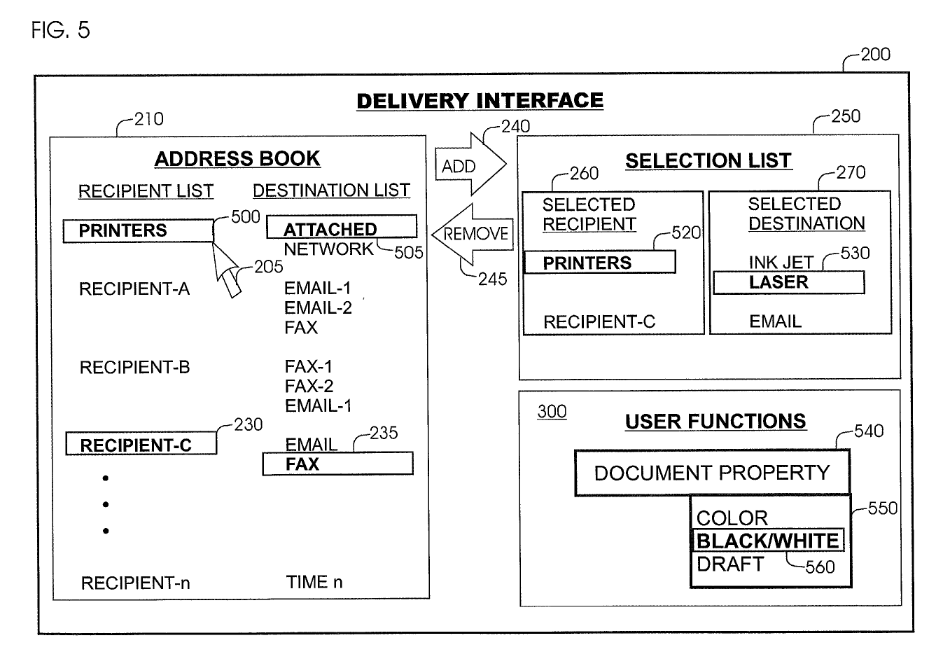

Another exemplary delivery interface 200 is shown in FIG. 5. Again, the delivery interface 200 may comprise windows for displaying an address book 210, the user's selections 250, and functions 300 available to the user. The user may specify a plurality of recipients for the document 110 using the delivery interface 200, as explained in more detail above. For example, the user has selected a recipient (i.e., RECIPIENT-C (230)) and a printers option (i.e., PRINTERS (500), as indicated by the boldface font and the box surrounding the selections, in FIG. 5. In addition, a document property function 540 may be provided so that the user may configure at least one document property for the document in electronic format.

As an illustration, the user may select PRINTERS 520, and more specifically, the LASER printer 530, as indicated by the boldface font and the boxes surrounding the selections in FIG. 5. According to this embodiment, the user may apply a document property (e.g., color, black/white, draft, etc.) selected from the document properties menu 550. In this example, the user has applied the BLACK/WHITE option 560. Preferably, program code is provided for configuring the document 110 for the selected property. For example, a color document may be converted to a black and white document, or a text file may be converted to a proprietary word processing format.

Different document properties may be applied to the document 110 based on the type of device that will receive the document 110 at the network destinations 140-143. That is, where the document 110 is sent to one recipient at an email account, it may be formatted as an HTML document, while the same document 110 that is sent to another of the plurality of recipients at a facsimile machine may be formatted as a black and white document. Hence, according to this embodiment, the same document 110 may be separately formatted for each recipient based at least in part on the type of the device receiving the document 110, without the user having to rescan the document 110. For example, the user may select the BLACK/WHITE option 560 to send the document 110 to the printer 520, and the user may select the COLOR option to send the document 110 to an email account.

Other document properties that may be configured according to the teachings of the invention may comprise properties such as draft, black/white, or color, compression (e.g., none or 1:2 compression ratio), password protection (e.g., none or password), and/or file type (e.g., bitmap or hypertext markup language (html)). Also, in other embodiments the user need not select the document properties, and instead, program code for optimizing the document properties for the type of network device may be provided. As an illustration, the document may be automatically formatted as a black and white, line art document when it is sent to a fax machine, as a full color document when it is send to a color printer or for display at a PC, etc. These settings may be configured by an administrator or by the user, and applied to the documents 110 that are then sent from the multifunction device 100.

It is understood that the embodiments of the delivery interface 200 shown and described above with respect to FIG. 2 through FIG. 5 are provided to illustrate the invention, and not to limit the scope of the invention thereto. Other embodiments are also contemplated as being within the scope of the invention. In another embodiment, for example, the user may first select the type of network destination (e.g., email, fax, etc.), and then manually enter the recipients' address(es) or select the same from an address book or distribution list for the selected function. Accordingly, this embodiment may be used with “function-centric” address books (e.g., an address book containing only email addresses, only fax numbers, etc.) without requiring one address book to contain each of the different types of addresses for each user (i.e., “recipient-centric” address books).

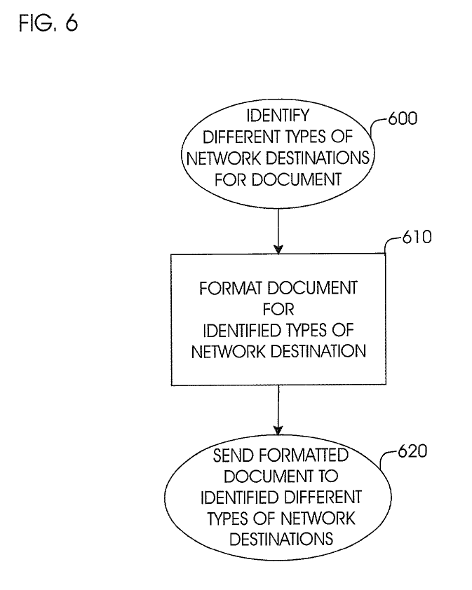

An embodiment of the methods for sending documents 110 from a multifunction device 100 to different types of network destinations 140-143 may be better understood with reference to the flow chart shown in FIG. 6. The different types of network destinations 140-143 are preferably identified, as shown in step 600. For example, the user may select recipients and/or network destinations 140-143 for the document 110, and program code may be provided for identifying the different types of network destinations 140-143 that are selected. The document 110 is preferably formatted for each of the different types of identified network destinations 140-143, as shown in step 610. For example, the document 110 may be formatted to send to a facsimile machine, an email account, a network printer, etc. The formatted document 110 is preferably sent in electronic format (e.g., as electronic document 120) from the multifunction device 100 to the identified different types of network destinations 140-143, as shown in step 620.

It is understood that the steps shown and described in FIG. 6, and the examples given with respect thereto, are merely illustrative of preferred embodiments of a method for sending documents 110 from a multifunction device 100 to different types of network destinations 140-143. However, other embodiments of the method are also contemplated as being within the scope of the invention. For example, other embodiments of the method may comprise modifications to the steps shown and described with respect to FIG. 6. Likewise, other embodiments of the method may comprise additional steps. It is also understood that the steps need not be performed in the order shown in FIG. 6. Furthermore, it is understood that the same steps may be performed in more than one manner according to various embodiments of the invention.

What is claimed is:

1. A document delivery method comprising:
identifying different types of network destinations for receiving a document;
formatting said document for each of said different types of network destinations without re-imaging said document; and
sending said formatted document to each of said different types of network destinations from a multifunction device.

2. The method of claim 1, wherein sending said formatted document to each of said different types of network destinations is via serial transmission.

3. The method of claim 1, further comprising converting said document to electronic format, wherein said electronic document is formatted and sent.

4. The method of claim 1, wherein identifying said different types of network destinations is based at least in part on a user selection.

5. The method of claim 1, wherein identifying said different types of network destinations is based at least in part on a user-identified limitation.

6. The method of claim 1, wherein formatting said document is based at least in part on a property of the different types of network destinations.

7. The method of claim 1, wherein formatting said document is based at least in part on a property of the document.

8. The method of claim 1, further comprising resending said document to at least one of said different types of network destinations upon a predetermined condition being satisfied.

9. The method of claim 8, wherein said predetermined condition is satisfied when said document is undeliverable to said at least one of said different types of network destinations.

10. The method of claim 8, wherein resending said document is according to a user-selected cycle function.

11. A document delivery method comprising:
converting a printed document to an electronic document only once with a multifunction device;
identifying different types of network destinations to receive said electronic document;
formatting said electronic document for each of said different types of network destinations; and
sending said formatted electronic document from said multifunction device to each of said identified different types of network destinations.

12. The method of claim 11, wherein sending said formatted document to each of said different types of network destinations is via serial transmission.

13. The method of claim 11, wherein identifying said different types of network destinations is based at least in part on a user-identified limitation.

14. The method of claim 11, wherein formatting said electronic document is based at least in part on the type of said network destination.

15. The method of claim 11, further comprising resending said electronic document to at least one of said different types of network destinations upon a predetermined condition being satisfied.

16. The method of claim 15, further comprising satisfying said predetermined condition when said electronic document is undeliverable to said at least one of said different types of network destinations.

17. The method of claim 15, wherein resending said electronic document is in response to a user-selected cycle function.

18. A multifunction device comprising computer-readable media operatively associated with said multifunction device and having computer-readable program code thereon including program code for identifying different types of network destinations to receive a document, program code for formatting said document for each of said different types of network destinations, and program code for sending said formatted document from said multifunction device to each of said different types of network destinations, wherein said document is imaged only once for delivery to each of said different types of network destinations.

19. The multifunction device of claim 18, further comprising an interface for receiving at least one user selection, wherein said program code for identifying said different types of network destinations bases said identification at least in part on said at least one user selection.

20. The multifunction device of claim 19, wherein said computer-readable program code comprises program code for limiting said different types of network destinations based on said at least one user selection.

21. The multifunction device of claim 18, further comprising a computer-readable address book for identifying said different types of network destinations.

22. The multifunction device of claim 18, wherein said computer-readable program code comprises program code for configuring a property of said document for each of said different types of network destinations.

23. The multifunction device of claim 18, further comprising program code for converting said document to electronic format.

24. The multifunction device of claim 18, wherein said computer-readable program code comprises program code for resending said document to at least one of said different types of network destinations upon a predetermined condition being satisfied.

25. The multifunction device of claim 24, wherein said predetermined condition is satisfied when said document is undeliverable to said at least one of said different types of network destinations.
